(19) United States
(12) Patent Application Publication
(10) Pub. No.: US 2025/0192296 A1
(43) Pub. Date: Jun. 12, 2025

(54) MULTI-TIERED BATTERY PACK SUPPORT ASSEMBLY

(71) Applicant: Ford Global Technologies, LLC, Dearborn, MI (US)

(72) Inventors: Derek Timothy Taylor, Waterford, MI (US); John Peter Bilezikjian, Canton, MI (US); Nicholas Braeseker, Novi, MI (US)

(21) Appl. No.: 18/677,421

(22) Filed: May 29, 2024

Related U.S. Application Data
(60) Provisional application No. 63/607,888, filed on Dec. 8, 2023.

(51) Int. Cl. H01M 50/204; B60L 50/60; H01M 10/613; H01M 10/6554; H01M 10/6556; H01M 50/249; H01M 50/271

(52) U.S. Cl. CPC H01M 50/204; H01M 10/613; H01M 10/6554; H01M 10/6556; H01M 50/249; H01M 50/271; B60L 50/60; H01M 2220/20

(57) ABSTRACT

A battery pack assembly includes a support assembly positioned between a first cell stack on an lower tier and a second cell stack on a upper tier. The support assembly is configured to transfer a load from a second divider of the second cell stack to a plurality of first dividers of the first cell stack. The second divider is horizontally offset from the plurality of first dividers.

### CROSS-REFERENCE TO RELATED APPLICATIONS

This disclosure claims the benefit of U.S. Provisional Application No. 63/607,888, which was filed on Dec. 8, 2023, and is incorporated herein by reference in its entirety.

### TECHNICAL FIELD

This disclosure relates generally to traction battery packs and, more particularly, to supporting an upper tier of cell stacks within a multi-tiered battery pack.

### BACKGROUND

Electrified vehicles include a traction battery pack for powering electric machines and other electrical loads of the vehicle. The traction battery pack can include cell stacks having a plurality of battery cells. The traction battery pack can further include various other battery internal components that support electric vehicle propulsion. Some battery packs include cell stacks arranged on multiple tiers.

### SUMMARY

In some aspects, the techniques described herein relate to a battery pack assembly, including: a support assembly positioned between a first cell stack on an lower tier and a second cell stack on a upper tier, the support assembly configured to transfer a load from a second divider of the second cell stack to a plurality of first dividers of the first cell stack, the second divider horizontally offset from the plurality of first dividers.

In some aspects, the techniques described herein relate to a battery pack assembly, wherein the support assembly is configured to transfer the load horizontally.

In some aspects, the techniques described herein relate to a battery pack assembly, wherein the support assembly includes a corrugated structure having a plurality of corrugations, the plurality of corrugations having peaks that are each disposed beneath a respective second divider of the second cell stack, the plurality of corrugations having valleys disposed atop a respective first divider within the plurality of first dividers.

In some aspects, the techniques described herein relate to a battery pack assembly, further including a thermal exchange plate disposed atop the support assembly, the thermal exchange plate sandwiched between the first cell stack and the support assembly.

In some aspects, the techniques described herein relate to a battery pack assembly, wherein the thermal exchange plate includes a plurality of coolant channels, wherein the support assembly is secured to the thermal exchange plate at positions between the plurality of coolant channels.

In some aspects, the techniques described herein relate to a battery pack assembly, wherein the support assembly extends horizontally past the first cell stack.

In some aspects, the techniques described herein relate to a battery pack assembly, wherein the support assembly extends horizontally past the first cell stack on a first side of the first cell stack, and horizontally past the first cell stack on an opposite, second side of the second cell stack.

In some aspects, the techniques described herein relate to a battery pack assembly, further including an enclosure tray having ribs that at least partially support the support assembly.

In some aspects, the techniques described herein relate to a battery pack assembly, further including a battery pack enclosure assembly housing the first cell stack and the second cell stack, wherein the support assembly extends in a first direction past the upper tier and the lower tier to a position between an enclosure tray and an enclosure cover of the battery pack enclosure assembly, and in a second direction past the upper tier and the lower tier to another position between the enclosure tray and the enclosure cover.

In some aspects, the techniques described herein relate to a battery pack assembly, wherein the support assembly extends in the first direction and the second direction between an enclosure tray of the battery pack enclosure assembly and an enclosure cover of the battery pack enclosure assembly.

In some aspects, the techniques described herein relate to a battery pack assembly, further including the first cell stack beneath the support assembly and the second cell stack above the support assembly.

In some aspects, the techniques described herein relate to a battery pack load management method, including: providing a support assembly above at least one first cell stack on a lower tier; supporting at least one second cell stack on an upper tier using a support assembly; and during the supporting, using the support assembly to route a load received from at least one second divider of the at least one second cell stack to at least one first divider of the at least one first cell stack, the at least one second divider and the at least one first divider horizontally offset from each other.

In some aspects, the techniques described herein relate to a battery pack load management method, further including a thermal exchange device sandwiched between the at least one first cell stack and the at least one second cell stack.

In some aspects, the techniques described herein relate to a battery pack load management method, wherein the support assembly is secured to the thermal exchange device at positions between coolant channels of the thermal exchange device.

In some aspects, the techniques described herein relate to a battery pack load management method, further including routing the load through the support assembly in a horizontal direction.

In some aspects, the techniques described herein relate to a battery pack load management method, further including supporting at least some of the support assembly with the at least one first cell stack.

In some aspects, the techniques described herein relate to a battery pack load management method, further including supporting at least some of the support assembly with an enclosure tray at positions that are outboard the at least one first cell stack.

In some aspects, the techniques described herein relate to a battery pack load management method, wherein the support assembly is corrugated.

In some aspects, the techniques described herein relate to a battery pack load management method, further including a cover of the at least one first cell stack, the cover sandwiched between the at least one first cell stack and the support assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates a perspective view of the battery pack of FIG. 1 according to an exemplary aspect of the present disclosure.

FIG. 3 illustrates a section view of the battery pack of FIG. 2 with an enclosure assembly of the battery pack removed to show cell stacks and a support assembly of the battery pack.

FIG. 4 illustrates a close up view of the support assembly of FIG. 3.

FIG. 5 illustrates a section view of a battery pack having a support assembly according to another exemplary aspect of the present disclosure.

### DETAILED DESCRIPTION

This disclosure details exemplary assemblies and methods utilized to support component within a multi-tiered battery pack. A support assembly can, for example, guide loads associated with an upper tier of cell stacks to dividers within a lower tier of cell stacks. These and other features are discussed in greater detail in the following paragraphs.

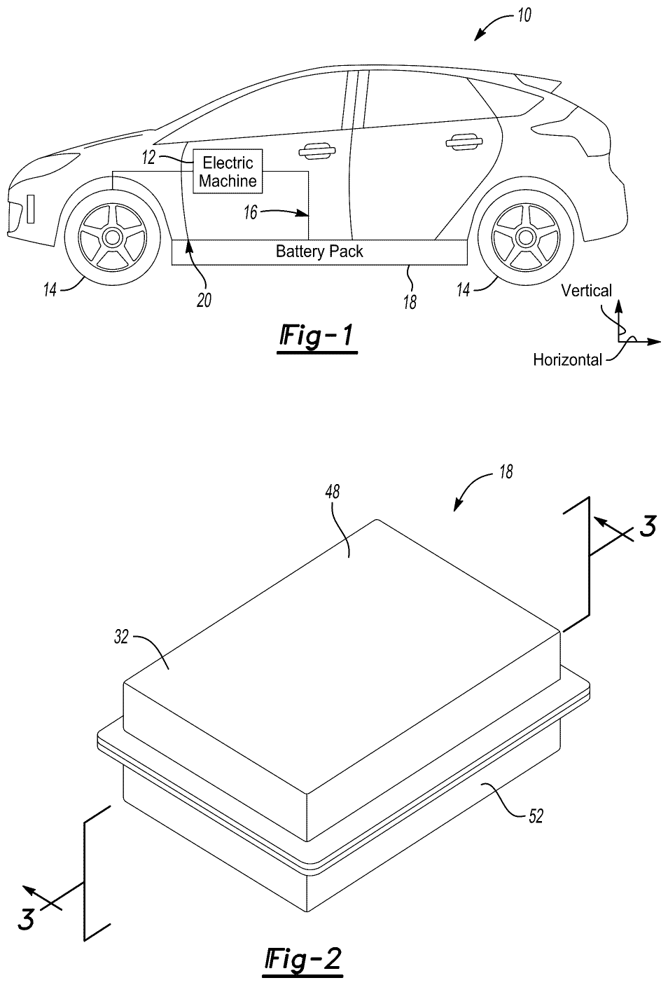

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 electrically couples the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 is secured to an underbody 20 of the electrified vehicle 10. However, the traction battery pack 18 could be located elsewhere on the electrified vehicle 10 in other examples.

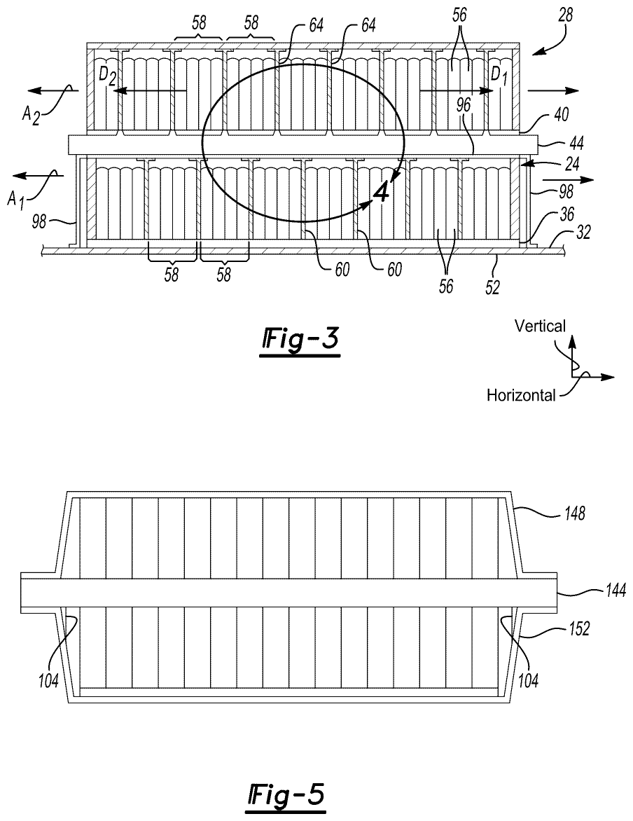

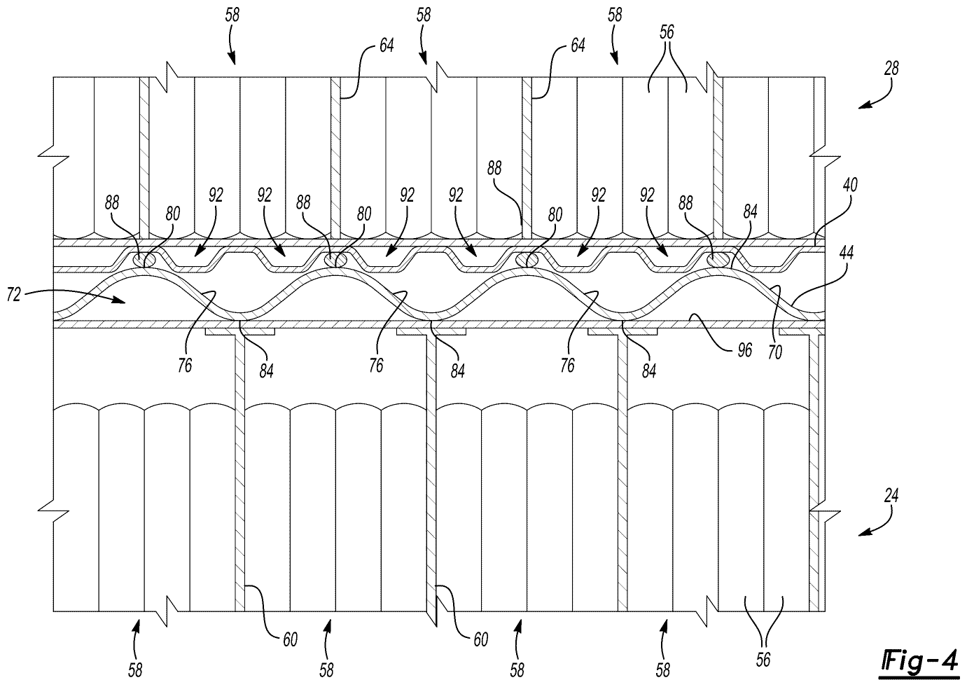

With reference to FIGS. 2-4, in an exemplary embodiment of the present disclosure, the traction battery pack 18 includes at least one first cell stack 24 and at least one second cell stack 28. The first cell stack 24 is on a lower tier of the battery pack 18. The second cell stack 28 is on a upper tier of the battery pack 18. The second cell stack 28 is thus vertically above the first cell stack 24. The traction battery pack 18 is a multi-tiered battery pack due to the battery pack 18 including cell stacks on more than one tier. Vertical and horizontal, for purposes of this disclosure, are with reference to ground and a general orientation of the electrified vehicle 10 during operation.

Although the lower tier includes the first cell stack 24, the lower tier could include more than one first cell stack 24. Although the upper tier includes the second cell stack 28, the upper tier could include more than one second cell stack. Further, although two tiers are shown in the example traction battery pack 18, other examples could include more than two tiers of cell stacks.

The example battery pack 18 further includes an enclosure assembly 32, a lower tier thermal exchange assembly 36, an upper tier thermal exchange assembly 40, and a support assembly 44. The upper tier thermal exchange assembly 40 and the at least one second cell stack 28 are supported on the support assembly 44. The upper tier thermal exchange assembly 40 is sandwiched between the support assembly 44 and the second cell stack 28.

The enclosure assembly 32 includes an enclosure cover 48 and an enclosure tray 52 that house the first cell stack 24 and the second cell stack 28.

The support assembly 44 extends horizontally in a first direction D1 past a first side of the first cell stack 24, and in an opposite, second direction D2 past an opposite, second side of the first cell stack 24. In this example, the support assembly 44 extends in the direction D1 to a position between the enclosure cover 48 and the enclosure tray 52, and extends in the direction D2 to a position between the enclosure cover 48 and the enclosure tray 52. The example support assembly 44 is directly supported by the enclosure tray 52 and the at least one first cell stack 24. The enclosure tray 52 can, in some examples, include ribs to help support the support assembly 44. In other examples, the support assembly 44 can be supported by the first cell stack 24 without the any direct support from the enclosure tray 52.

The first cell stack 24 includes a plurality of individual battery cells 56 stacked side-by-side relative to one another along a cell stack axis A1. The second cell stack 28 includes a plurality of individual battery cells 56 stacked side-by-side along a cell stack axis A2. While the example embodiment shows one first cell stack 24 and one second cell stack 28, other examples could include more than one first cell stack 24 on the lower tier and more than one second cell stack 28 on the upper tier.

In the exemplary embodiment, the battery cells 56 are lithium-ion, prismatic battery cells. However, battery cells having other geometries (cylindrical, pouch, etc.) and/or chemistries (nickel-metal hydride, lead-acid, etc.) could alternatively be utilized within the scope of this disclosure.

The battery cells 56 are arranged in groups 58 along the respective cell stack axis A1, A2. The first cell stack 24 includes a plurality of dividers 60, which separate groups 58 of battery cells 56 from each other along the respective cell stack axis A1. The second cell stack 28 includes a plurality of dividers 64, which separate groups 58 of battery cells 56 from each other along the cell stack axis A2. In this example, the groups each include two or four individual battery cells 56. Other numbers of battery cells 56 could be included in the groups 58 in other examples. In some examples, each group 58 could include a single battery cell 56.

The dividers 60 and the dividers 64 have I-shaped cross-sections in this example. The dividers 60 and the dividers 64 can be metal or metal alloy. Notably, the dividers 60 in the at least one first cell stack 24 are horizontally offset from the dividers 64 in the at least one second cell stack 28.

The support assembly 44 is configured to transfer a load from the dividers 64 of the second cell stack 28 to the dividers 60 of the first cell stack 24. The load can be due to the weight of the second cell stack 28 and the upper tier thermal exchange assembly 40.

To transfer the load, the support assembly 44, in this example, includes a corrugated structure 72 having a plurality of corrugations 76. The corrugated structure 72 can facilitate strengthening the support assembly 44.

Each of the corrugations 76 has a respective peak 80, which is disposed vertically directly beneath one of the dividers 64 in the second cell stack 28. The corrugated structure 72 includes valleys 84 between the corrugations 76. The valleys 84 are disposed vertically directly above one of the dividers 60 in the first cell stack 24. An adhesive 88 or spacer can be placed between the peaks 80 of the support assembly 44 and the second cell stack 28.

The support assembly 44 receives a load associated with supporting the second cell stack 28 and the upper tier thermal exchange assembly 40 at the peaks 80 of the corrugated structure 72, which then guides a load outboard. The corrugated structure 72 guides the load outboard to the dividers 60 of the first cell stack 24. As the dividers 60 are horizontally offset from the dividers 64, the support assembly 44 guides the load, at least partially, horizontally. In this example, the first cell stack 24 includes a cover 96. The load passes through the cover 96 to the dividers 60.

The upper tier thermal exchange assembly 40 can be considered a cold plate. The upper tier thermal exchange assembly 40 includes coolant channels 92 that communicate a liquid coolant to take on thermal energy from the second cell stack 28. The peaks 80 of the support assembly 44 are disposed at positions between the coolant channels 92.

The example support assembly 44 is supported by a pair of dividers 98 along with the first cell stack 24. With reference to the schematic side view of FIG. 5, another example support assembly 144 can be supported by an enclosure tray 152. The support assembly 144 can, as shown, extend outboard between the enclosure tray 152 and an enclosure cover 148. The enclosure tray 152 can be formed with strengthening ribs 104 that at least partially support the enclosure tray 152.

Features of the disclosed examples include a load management method associated with the battery pack thus includes routing a load from an upper tier cell stack at least partially horizontally into a plurality of dividers of a lower tier cell stack. The load passes through the lower tier cell stack rather than just passing through structures outside a perimeter of the lower tier cell stack.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a support assembly positioned between a first cell stack on an lower tier and a second cell stack on a upper tier, the support assembly configured to transfer a load from a second divider of the second cell stack to a plurality of first dividers of the first cell stack, the second divider horizontally offset from the plurality of first dividers.

2. The battery pack assembly of claim 1, wherein the support assembly is configured to transfer the load horizontally.

3. The battery pack assembly of claim 1, wherein the support assembly comprises a corrugated structure having a plurality of corrugations, the plurality of corrugations having peaks that are each disposed beneath a respective second divider of the second cell stack, the plurality of corrugations having valleys disposed atop a respective first divider within the plurality of first dividers.

4. The battery pack assembly of claim 1, further comprising a thermal exchange plate disposed atop the support assembly, the thermal exchange plate sandwiched between the first cell stack and the support assembly.

5. The battery pack assembly of claim 4, wherein the thermal exchange plate includes a plurality of coolant channels, wherein the support assembly is secured to the thermal exchange plate at positions between the plurality of coolant channels.

6. The battery pack assembly of claim 1, wherein the support assembly extends horizontally past the first cell stack.

7. The battery pack assembly of claim 1, wherein the support assembly extends horizontally past the first cell stack on a first side of the first cell stack, and horizontally past the first cell stack on an opposite, second side of the second cell stack.

8. The battery pack assembly of claim 1, further comprising an enclosure tray having ribs that at least partially support the support assembly.

9. The battery pack assembly of claim 1, further comprising a battery pack enclosure assembly housing the first cell stack and the second cell stack, wherein the support assembly extends in a first direction past the upper tier and the lower tier to a position between an enclosure tray and an enclosure cover of the battery pack enclosure assembly, and in a second direction past the upper tier and the lower tier to another position between the enclosure tray and the enclosure cover.

10. The battery pack assembly of claim 9, wherein the support assembly extends in the first direction and the second direction between an enclosure tray of the battery pack enclosure assembly and an enclosure cover of the battery pack enclosure assembly.

11. The battery pack assembly of claim 1, further comprising the first cell stack beneath the support assembly and the second cell stack above the support assembly.

12. A battery pack load management method, comprising:
providing a support assembly above at least one first cell stack on a lower tier;
supporting at least one second cell stack on an upper tier using a support assembly; and
during the supporting, using the support assembly to route a load received from at least one second divider of the at least one second cell stack to at least one first divider of the at least one first cell stack, the at least one second divider and the at least one first divider horizontally offset from each other.

13. The battery pack load management method of claim 12, further comprising a thermal exchange device sandwiched between the at least one first cell stack and the at least one second cell stack.

14. The battery pack load management method of claim 13, wherein the support assembly is secured to the thermal exchange device at positions between coolant channels of the thermal exchange device.

15. The battery pack load management method of claim 12, further comprising routing the load through the support assembly in a horizontal direction.

16. The battery pack load management method of claim 14, further comprising supporting at least some of the support assembly with the at least one first cell stack.

17. The battery pack load management method of claim 16, further comprising supporting at least some of the support assembly with an enclosure tray at positions that are outboard the at least one first cell stack.

18. The battery pack load management method of claim 12, wherein the support assembly is corrugated.

19. The battery pack load management method of claim 12, further comprising a cover of the at least one first cell stack, the cover sandwiched between the at least one first cell stack and the support assembly.
